(19) United States
(12) Patent Application Publication
(10) Pub. No.: US 2011/0228934 A1
(43) Pub. Date: Sep. 22, 2011

(54) COMMUNICATION DEVICE AND COMMUNICATION METHOD

(75) Inventor: Isamu Fukuda, Kawasaki (JP)

(73) Assignee: FUJITSU LIMITED, Kawasaki-shi (JP)

(21) Appl. No.: 13/036,306

(22) Filed: Feb. 28, 2011

(30) Foreign Application Priority Data
Mar. 18, 2010 (JP) 2010-63372

(51) Int. Cl. H04K 1/00

(52) U.S. Cl. 380/255

(57) ABSTRACT

A communication device includes: a first monitoring unit that monitors a first lifetime until a data amount transmitted through a first encryption communication path established between the communication device and another communication device exceeds a first threshold, a second monitoring unit that monitors a second lifetime until the data amount transmitted through the first encryption communication path exceeds a second threshold that is larger than the first threshold, a communication path establishing unit that establishes a second encryption communication path different from the first encryption communication path between the communication device and the another communication device when the first lifetime has expired, and a communication path deleting unit that deletes the first encryption communication path when the data amount transmitted through the second encryption communication path exceeds a remaining data amount of the second lifetime.

### CROSS-REFERENCE TO RELATED APPLICATION

This application is based upon and claims the benefit of priority of the prior Japanese Patent Application No. 2010-63372, filed on Mar. 18, 2010, the entire contents of which are incorporated herein by reference.

### FIELD

A certain aspect of the embodiments discussed herein relates to a communication device that carries out communication and a communication method.

### BACKGROUND

For example, Long Term Evolution (LTE) uses Security Architecture for Internet Protocol (IPsec) to set an IP tunnel (SA: Security Association) that transmits packets between a Node A and a Node B. An encryption key exchange (rekey) is used to maintain encryption strength in the IPsec.

The encryption key exchange occurs when, for example, a certain period of validity (lifetime) is expired. The lifetime may be decided according to the length of time that has elapsed from the establishment of an SA, or according to the transmission byte count transmitted by the SA. Specifically, a soft threshold and a hard threshold are set for the elapsed time and the transmission byte count respectively. The soft threshold is smaller than the hard threshold. Thus, if the elapsed time or the transmission byte count exceeds the soft threshold, a new SA is established (key exchange). Further, if the elapsed time or the transmission byte count exceeds the hard threshold, the SA is deleted (invalidated).

Furthermore, a method of deleting the SA when the old SA hard lifetime expires after the key exchange is known (for example, see Japanese Unexamined Patent Application Publication No. 2006-191537). Japanese Unexamined Patent Application Publication No. 2006-191537 discloses a method of monitoring the hard lifetime by a timer set before the key exchange and deleting the old SA when the lifetime expires. Japanese Unexamined Patent Application Publication No. 2006-191537 further discloses a method of monitoring the old SA idle time and deleting the old SA, and a method of adding a new timer and deleting the old SA when the new timer expires.

### SUMMARY

According to an aspect of an embodiment, a communication device includes: a first monitoring unit that monitors a first lifetime until a data amount transmitted through a first encryption communication path established between the communication device and another communication device exceeds a first threshold, a second monitoring unit that monitors a second lifetime until the data amount transmitted through the first encryption communication path exceeds a second threshold that is larger than the first threshold, a communication path establishing unit that establishes a second encryption communication path different from the first encryption communication path between the communication device and the another communication device when the first lifetime monitored by the first monitoring unit has expired, and a communication path deleting unit that deletes the first encryption communication path when the data amount transmitted through the second encryption communication path established by the communication path establishing unit exceeds a remaining data amount of the second lifetime monitored by the second monitoring unit.

### BRIEF DESCRIPTION OF DRAWINGS

FIG. 1 is a block diagram of a configuration of a communication device according to a first embodiment;

FIG. 2 illustrates an example of information stored in a memory of the communication device according to the first embodiment;

FIG. 3 illustrates an example of deleting an old SA by the communication device according to the first embodiment;

FIG. 4 is a flow chart illustrating an example of operations by the communication device according to the first embodiment;

FIG. 5 is a sequence diagram illustrating an example of communication system operations according to the first embodiment;

FIG. 6 is a flow chart illustrating an example of operations by the communication device according to a second embodiment;

FIG. 7 is a sequence diagram illustrating an example of communication system operations according to the second embodiment;

FIG. 8 is a block diagram of a configuration of a communication device according to a third embodiment;

FIG. 9 illustrates an example of information stored in a memory of the communication device according to the third embodiment;

FIG. 10 illustrates an example of deleting an old SA by the communication device according to the third embodiment;

FIG. 11 is a flow chart illustrating an example of operations by the communication device according to the third embodiment;

FIG. 12 is a sequence diagram illustrating an example of communication system operations according to the third embodiment;

FIG. 13 is a block diagram of a configuration of a communication device according to a fourth embodiment;

FIG. 14 is a flow chart illustrating an example of operations by the communication device according to the fourth embodiment;

FIG. 15 is a sequence diagram illustrating an example of communication system operations according to the fourth embodiment;

FIG. 16 is a first application example of a communication system according to the embodiments; and

FIG. 17 is a second application example of a communication system according to the embodiments.

### DESCRIPTION OF EMBODIMENTS

The aforementioned prior art has a problem such that communication resources cannot be used effectively. For example, in the technique disclosed in Japanese Unexamined Patent Application Publication No. 2006-191537, a new SA is established when the byte soft threshold is exceeded, but the old SA is not deleted until the time hard threshold is exceeded. This is because when the key exchange occurs, packet communication switches from the old SA to the new SA and the byte count of the old SA is not updated.

Therefore, when the byte threshold is smaller than the time threshold, the key exchange is repeated and multiple SAs are established in the period until the old SA time hard threshold is exceeded. As a result, communication resources are depleted and a new SA cannot be generated and communication breaks down. As a result, operation runarounds such as setting the byte threshold large enough in comparison to the time threshold or invalidating the key exchange based on the byte threshold may be considered. However, in these cases, the key exchange is not carried out frequently enough and encryption strength cannot be maintained.

Furthermore, the method of monitoring the old SA idle time and deleting the old SA, and the method of adding a new timer and deleting the old SA when the lifetime has expired have a problem in that the processing load is increased.

It is an object of the communication device and communication method of the embodiments to address the above problems and use communication resources effectively.

To address the problems and meet the object described above, a technique of the embodiments monitors a first lifetime until a data amount transmitted through a first encryption communication path established between a communication device and another communication device exceeds a first threshold, monitors a second lifetime until the data amount transmitted through the first encryption communication path exceeds a second threshold that is larger than the first threshold, establishes a second encryption communication path larger than the first encryption communication path between the communication device and the another communication device when the monitored first lifetime expires, and deletes the first encryption communication path when the data amount transmitted through the established second encryption communication path exceeds a remaining data amount of the monitored second lifetime.

Using the communication device and communication method of the embodiments allows for the effective use of communication resources.

Preferred embodiments of the communication device and communication method will be explained with reference to the drawings.

### First Embodiment

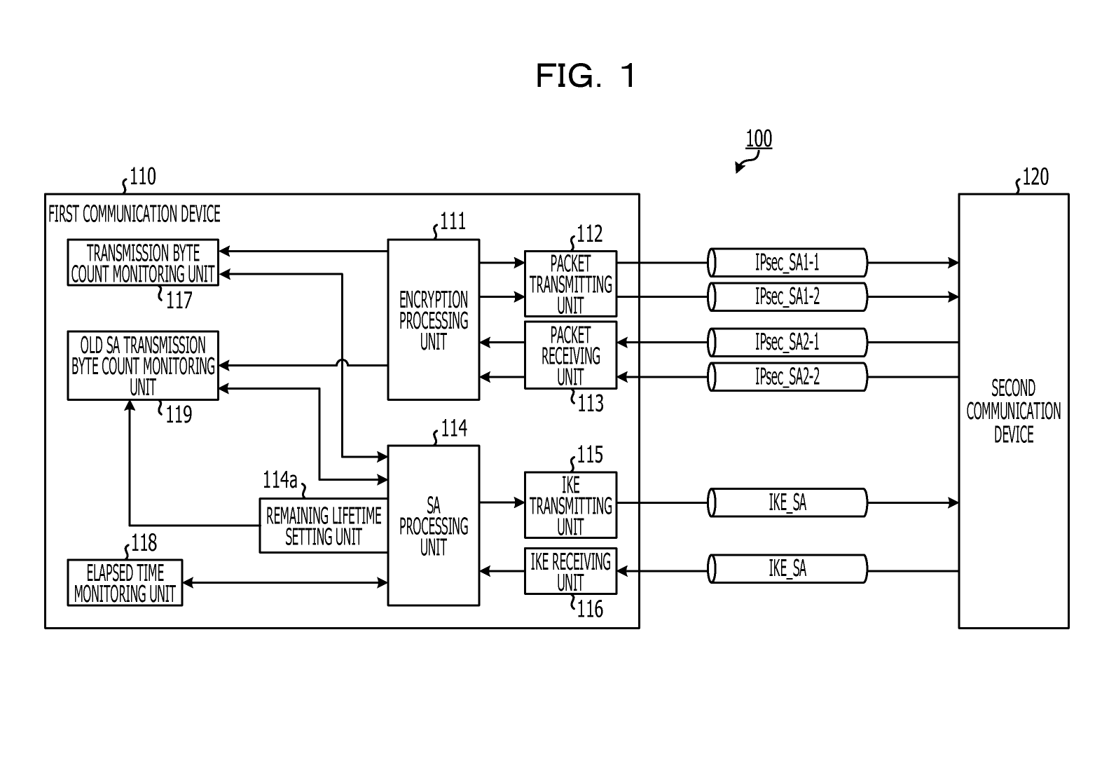

FIG. 1 is a block diagram of a configuration of a communication device according to a first embodiment. A communication system 100 according to the first embodiment includes a first communication device 110 and a second communication device 120. The first communication device 110 communicates with the second communication device 120 through IPsec for example. In the following description, SAs established between the first communication device 110 and the second communication device 120 shall be referred to as a “current SA” for the newest SA, and an “old SA” for an SA that is not the newest.

The first communication device 110 deletes the old SA when the remaining data amount of the old SA byte hard lifetime is transmitted through the current SA. As a result, keeping the old SA and establishing multiple SAs can be avoided and communication resources can be used effectively.

As illustrated in FIG. 1, the first communication device 110 includes an encryption processing unit 111, a packet transmitting unit 112, a packet receiving unit 113, an SA processing unit 114, an IKE (Internet Key Exchange) transmitting unit 115, an IKE receiving unit 116, a transmission byte count monitoring unit 117, an elapsed time monitoring unit 118, and an old SA transmission byte count monitoring unit 119.

The encryption processing unit 111 conducts encryption processing in the SA (encryption communication path) established by the SA processing unit 114. Specifically, the encryption processing unit 111 encrypts packets to be transmitted to the second communication device 120 and outputs those packets to the packet transmitting unit 112. Furthermore, the encryption processing unit 111 decrypts packets outputted from the packet receiving unit 113 that has received the packets from the second communication device 120. Furthermore, the encryption processing unit 111 reports the byte count (data amount) transmitted through the SAs to the transmission byte count monitoring unit 117 and the old SA transmission byte count monitoring unit 119 for each SA.

The packet transmitting unit 112 transmits packets outputted from the encryption processing unit 111 to the second communication device 120 (IPsec_SA1-1 or IPsec_SA1-2). The packet receiving unit 113 receives packets transmitted from the second communication device 120 (IPsec_SA2-1 or IPsec_SA2-2) and outputs the packets to the encryption processing unit 111.

The SA processing unit 114 conducts processing to establish an SA (IPsec tunnel) to the second communication device 120 when communication begins between the first communication device 110 and the second communication device 120. The establishing and deleting of SAs by the SA processing unit 114 is conducted using IKE protocol (Internet Key Exchange Protocol) signals transmitted to and received from the second communication device 120. Specifically, the SA processing unit 114 outputs an IKE protocol signal to the IKE transmitting unit 115. Furthermore, the SA processing unit 114 acquires an outputted IKE protocol signal from the IKE receiving unit 116.

IKE protocol signals include SA generation requests for requesting the establishment of an SA at the start of communication, key exchange requests for requesting the establishment of a new SA during communication, and SA deletion requests for deleting established SAs. The SA processing unit 114 deletes the current SA upon receiving an SA deletion request from the second communication device 120. Furthermore, the SA processing unit 114 conducts a process (key exchange) to establish a new SA between the first and second communication devices 110 and 120 when a key exchange request is received from the second communication device 120.

Furthermore, the SA processing unit 114 sets soft and hard thresholds for established SAs in the transmission byte count monitoring unit 117. In the following description, the soft threshold set in the transmission byte count monitoring unit 117 will be called a byte soft threshold. The hard threshold set in the transmission byte count monitoring unit 117 will be called a byte hard threshold. The value of the byte hard threshold is set higher than the value of the byte soft threshold (for example, 3 times greater than the byte soft threshold).

Furthermore, the SA processing unit 114 sets soft and hard thresholds for established SAs in the elapsed time monitoring unit 118. In the following description, the soft threshold set in the elapsed time monitoring unit 118 will be called a time soft threshold. The hard threshold set in the elapsed time monitoring unit 118 will be called a time hard threshold. The value of the time hard threshold is set higher than the value of the time soft threshold (for example, three times greater than the time soft threshold).

The SA processing unit 114 conducts a key exchange to establish a new SA between the first and second communication devices 110 and 120 when the transmission byte count monitoring unit 117 reports that the SA byte soft lifetime is expired. The SA processing unit 114 conducts a key exchange to establish a new SA between the first and second communication devices 110 and 120 when the elapsed time monitoring unit 118 reports that the SA time soft lifetime is expired.

The SA processing unit 114 deletes (invalidates) the SA whose byte hard lifetime has expired when the transmission byte count monitoring unit 117 reports that the SA byte hard lifetime has expired. The SA processing unit 114 deletes the SA whose time hard lifetime has expired when the elapsed time monitoring unit 118 reports that the SA time hard lifetime has expired.

The SA processing unit 114 also includes a remaining lifetime setting unit 114a. The remaining lifetime setting unit 114a (setting unit) sets a byte count as an old SA threshold (third threshold) in the old SA transmission byte count monitoring unit 119. This byte count corresponds to the remaining byte hard lifetime of the SA with the expired byte soft lifetime. The SA processing unit 114 deletes the old SA when the old SA transmission byte count monitoring unit 119 reports that the old SA remaining byte lifetime has expired.

The IKE transmitting unit 115 transmits, to the second communication device 120, the IKE protocol signals outputted from the SA processing unit 114 (IKE_SA). The IKE receiving unit 116 receives IKE protocol signals transmitted from the second communication device 120, and outputs the signals to the SA processing unit 114.

The transmission byte count monitoring unit 117 acquires the byte count (data amount) of the packets transmitted by the current SA based on the byte count of the current SA reported by the encryption processing unit 111. The transmission byte count monitoring unit 117 (first monitoring unit) monitors the byte soft lifetime (first lifetime) up to when the acquired byte count exceeds the byte soft threshold (first threshold). The transmission byte count monitoring unit 117 notifies the SA processing unit 114 that the byte soft lifetime is expired when the byte soft lifetime has expired.

Furthermore, the transmission byte count monitoring unit 117 (second monitoring unit) monitors the byte hard lifetime (second lifetime) up to when the acquired byte count exceeds the byte hard threshold (second threshold). The transmission byte count monitoring unit 117 notifies the SA processing unit 114 that the byte hard lifetime is expired when the byte hard lifetime has expired.

The elapsed time monitoring unit 118 acquires the elapsed time after the current SA is established. The elapsed time monitoring unit 118 monitors the time soft lifetime up to when the acquired elapsed time exceeds the time soft threshold. The elapsed time monitoring unit 118 notifies the SA processing unit 114 that the time soft lifetime is expired when the time soft lifetime has expired.

The elapsed time monitoring unit 118 monitors the time hard lifetime up to when the acquired elapsed time exceeds the time hard threshold. The elapsed time monitoring unit 118 notifies the SA processing unit 114 that the time hard lifetime is expired when the time hard lifetime has expired.

The old SA transmission byte count monitoring unit 119 (third monitoring unit) monitors the old SA remaining byte lifetime (third lifetime) based on the current SA byte count reported by the encryption processing unit 111. The old SA remaining byte lifetime is the lifetime up to when the byte count transmitted through the current SA exceeds the old SA threshold. The old SA transmission byte count monitoring unit 119 notifies the SA processing unit 114 that the old SA remaining byte lifetime is expired when the old SA remaining byte lifetime has expired.

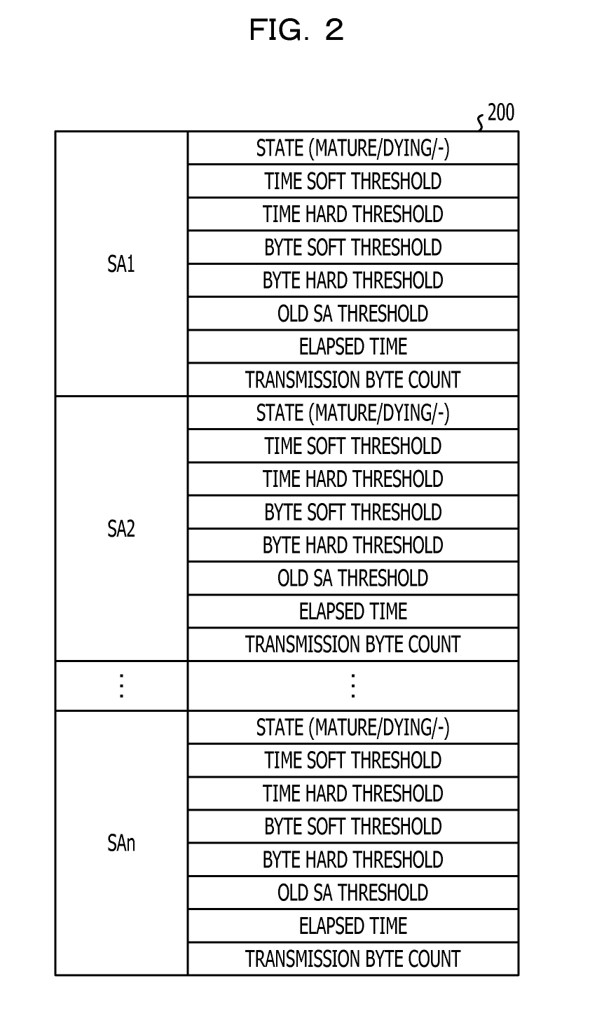

FIG. 2 illustrates an example of information stored in a memory of the communication device according to the first embodiment. A table 200 illustrated in FIG. 2 is an example of information stored in a memory of the first communication device 110. As illustrated in the table 200, the first communication device 110 stores “state,” “time soft threshold,” “time hard threshold,” “byte soft threshold,” “byte hard threshold,” “old SA threshold,” “elapsed time,” and “transmission byte count” for each SA (SA1 to SAn).

The “state” indicates the state of the SA managed by the SA processing unit 114. Specifically, a “Mature” state indicates that the corresponding SA is operating, a “Dying” state indicates that the corresponding SA is switching, and a “−” state indicates that either the corresponding SA is not established yet or that the corresponding SA has been deleted.

“Time soft threshold” and “time hard threshold” are thresholds set in the elapsed time monitoring unit 118 by the SA processing unit 114. “Byte soft threshold” and “byte hard threshold” are thresholds set in the transmission byte count monitoring unit 117 by the SA processing unit 114.

“Old SA threshold” is a threshold set in the old SA transmission byte count monitoring unit 119 by the SA processing unit 114. “Elapsed time” is the elapsed time from when the corresponding SA was established. “Transmission byte count” is the byte count of the packets transmitted through the corresponding SA.

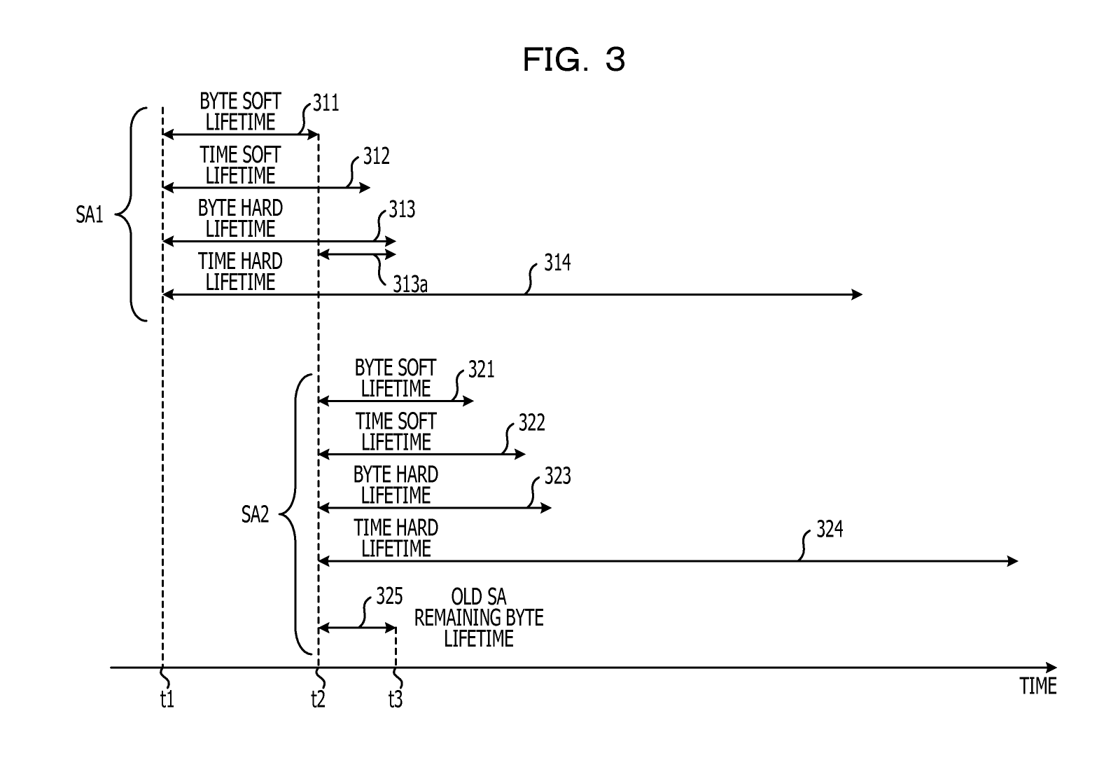

FIG. 3 illustrates an example of deleting an old SA by the communication device according to the first embodiment. The horizontal axis represents time in the graph in FIG. 3. At a time t1, an SA1 is established between the first communication device 110 and the second communication device 120. When the SA1 is established, a byte soft lifetime 311, a time soft lifetime 312, a byte hard lifetime 313, and a time hard lifetime 314 are set in the first communication device 110.

The byte soft lifetime 311 is the lifetime from the time t1 up to when the SA1 transmission byte count exceeds the byte soft threshold. The time soft lifetime 312 is the lifetime from the time t1 up to when the elapsed time exceeds the time soft threshold. The byte hard lifetime 313 is the lifetime from the time t1 up to when the SA1 transmission byte count exceeds the byte hard threshold (which is greater than the byte soft threshold). The time hard lifetime 314 is the lifetime from the time t1 until the elapsed time exceeds the time hard threshold (which is greater than the time soft threshold).

The following describes a case in which the byte soft lifetime 311 expires before the time soft lifetime 312. The time when the byte soft lifetime 311 expires shall be time t2. In this case, an SA2 is established between the first communication device 110 and the second communication device 120 at the time t2. When the SA2 is established, a byte soft lifetime 321, a time soft lifetime 322, a byte hard lifetime 323, and a time hard lifetime 324 are set in the first communication device 110.

The byte soft lifetime 321 is the lifetime from the time t2 up to when the SA2 transmission byte count exceeds the byte soft threshold. The time soft lifetime 322 is the lifetime from the time t2 up to when the elapsed time exceeds the time soft threshold. The byte hard lifetime 323 is the lifetime from the time t2 up to when the SA2 transmission byte count exceeds the byte hard threshold (which is greater than the byte soft threshold). The time hard lifetime 324 is the lifetime from the time t2 until the elapsed time exceeds the time hard threshold (which is greater than the time soft threshold).

The first communication device 110 sets an old SA remaining byte lifetime 325 for the SA2. The old SA remaining byte lifetime 325 is the lifetime from the time t2 up to when the SA2 transmission byte count exceeds the remaining byte count 313a of the byte hard lifetime 313 for the SA1 (old SA). Then the first communication device 110 deletes the SA1 at a time t3 when the old SA remaining byte lifetime 325 expires.

In this way, the old SA remaining byte lifetime 325 of the SA2 is monitored by setting an old SA threshold (third threshold) that corresponds to the remaining byte count 313a of the byte hard lifetime 313 when the byte soft lifetime 311 is expired. Then, the SA1 is deleted when the old SA remaining byte lifetime 325 is expired. As a result, the SA1 can be deleted when the byte count transmitted through the SA2 exceeds the remaining byte count 313a of the SA1 byte hard lifetime 313.

Thus, keeping the SA1 for a long time after the SA2 has been established can be avoided even if the time hard lifetime 314 is set as a long time. Furthermore, an increase in processing load can be prevented since the old SA remaining byte lifetime 325 can be monitored in the SA2 processing without returning to the SA1 processing after the SA2 has been established.

Alternatively, the transmission byte count monitoring unit 117 may be made to monitor the third lifetime until the sum of the SA1 transmission byte count and the SA2 transmission byte count exceeds the byte hard threshold after the SA2 has been established. Then the SA processing unit 114 deletes the SA1 when the third lifetime has expired.

As a result, the SA1 can be deleted when the byte count transmitted through the SA2 exceeds the remaining byte count 313a of the SA1 byte hard lifetime 313. Thus, keeping the SA1 for a long time after the SA2 has been established can be avoided even if the time hard lifetime 314 is set as a long time. In this case, the old SA transmission byte count monitoring unit 119 may be omitted from the configuration illustrated in FIG. 1.

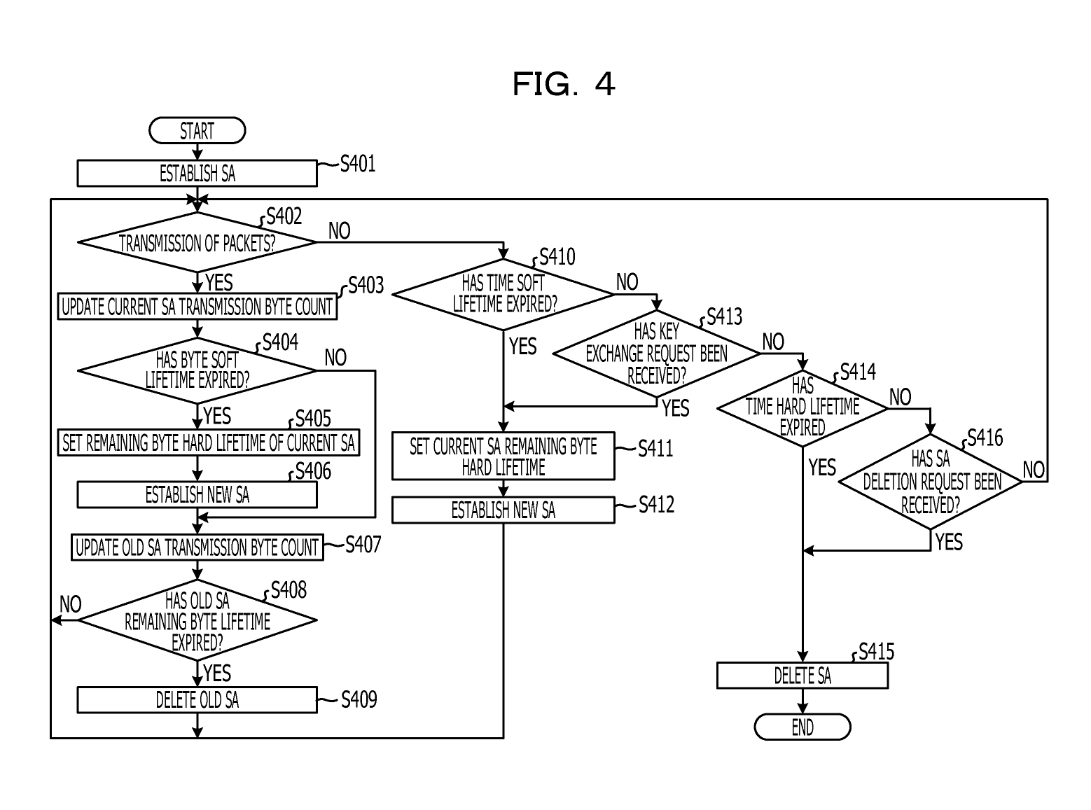

FIG. 4 is a flow chart illustrating an example of operations by the communication device according to the first embodiment. The first communication device 110 illustrated in FIG. 1 executes, for example, the following operations. First, the SA processing unit 114 establishes an SA between the first and second communication devices 110 and 120 when communication between the first and second communication devices 110 and 120 begins (operation S401). Next, the encryption processing unit 111 determines whether or not packets have been transmitted through the current SA (operation S402).

When the transmission of packets has been determined in operation S402 (operation S402: Yes), the transmission byte count monitoring unit 117 updates the byte count transmitted through the current SA by the byte count of the transmitted packets (operation S403). Next, the transmission byte count monitoring unit 117 determines whether or not the byte soft lifetime has expired based on the updating in operation S403 (operation S404). If the byte soft lifetime has not expired (operation S404: No), the process moves to operation S407.

If the byte soft lifetime has expired (operation S404: Yes), the remaining lifetime setting unit 114a sets the current SA remaining byte hard lifetime as the old SA remaining byte lifetime (operation S405). Next, the SA processing unit 114 establishes a new SA between the first and second communication devices 110 and 120 (operation S406).

Next, the old SA transmission byte count monitoring unit 119 updates the old SA transmission byte count by the byte count of the packets transmitted as determined in operation S402 (operation S407). Next, the old SA transmission byte count monitoring unit 119 determines whether or not the old SA remaining byte lifetime has expired based on the updating in operation S407 (operation S408).

When the old SA remaining byte lifetime has not expired (operation S408: No), the process returns to operation S402. If the old SA remaining byte lifetime has expired (operation S408: Yes), the SA processing unit 114 deletes the old SA (operation S409) and the process returns to operation S402.

When there is no packet transmission (operation S402: No), the elapsed time monitoring unit 118 determines whether or not the time soft lifetime of the current SA has expired (operation S410). If the time soft lifetime has expired (operation S410: Yes), the remaining lifetime setting unit 114a sets the current SA remaining byte hard lifetime as the old SA remaining byte lifetime (operation S411).

Next, the SA processing unit 114 establishes a new SA between the first and second communication devices 110 and 120 (operation S412) and the process returns to operation S402. If the time soft lifetime is not expired (operation S410: No), the SA processing unit 114 determines whether or not a key exchange request has been received using the IKE protocol from the second communication device 120 (operation S413). If the key exchange request has been received (operation S413: Yes), the process proceeds to operation S411.

If the key exchange request has not been received (operation S413: No), the elapsed time monitoring unit 118 determines whether or not an SA with an expired time hard lifetime exists (operation S414). If an SA with an expired time hard lifetime exists (operation S414: Yes), the SA with the expired time hard lifetime is deleted (operation S415) and the series of operations are finished.

If an SA with an expired time hard lifetime does not exist (operation S414: No), the SA processing unit 114 determines whether or not an SA deletion request has been received using the IKE protocol from the second communication device 120 (operation S416). If an SA deletion request has been received (operation S416: Yes), the process moves to operation S415 and the SA processing unit 114 deletes the SA based on the SA deletion request. If an SA deletion request has not been received (operation S416: No), the process returns to operation S402.

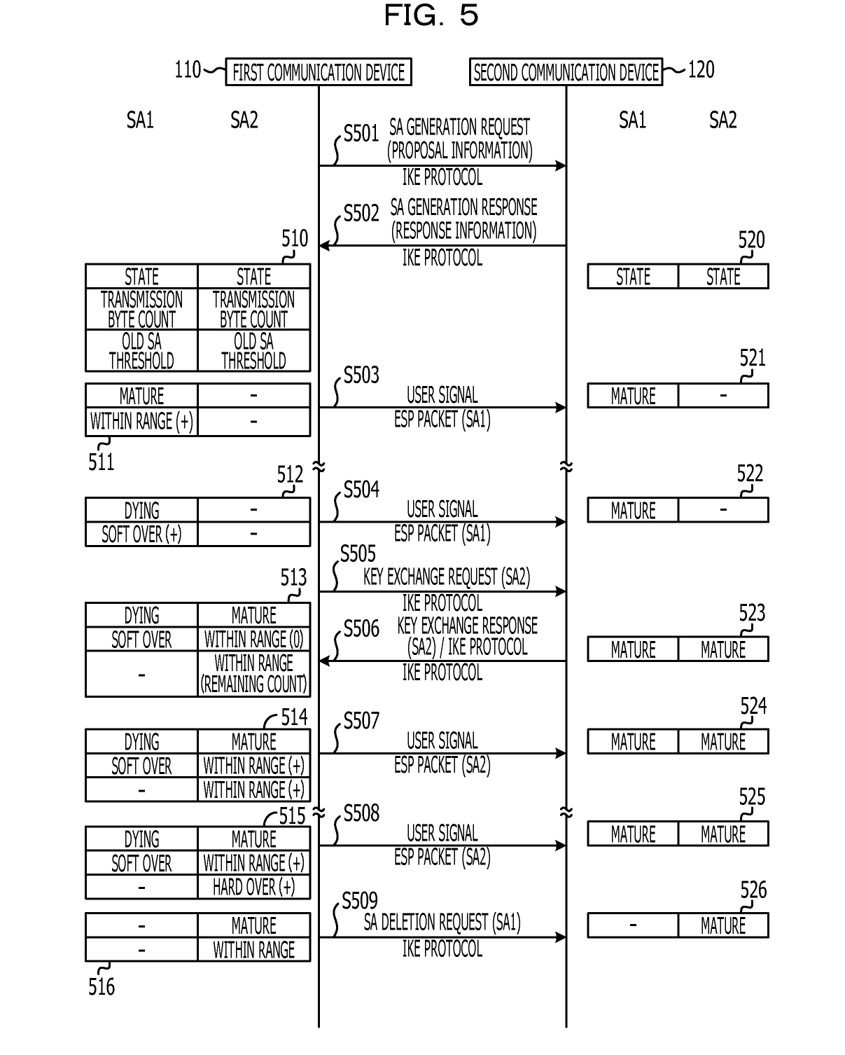

FIG. 5 is a sequence diagram illustrating an example of communication system operations according to the first embodiment. Tables 511 to 516 indicate parameters (see table 510) of the first communication device 110 for operations S503, S504, and S506 to S509 respectively. Tables 521 to 526 indicate parameters (see table 520) of the second communication device 120 for operations S503, S504, and S506 to S509 respectively.

First, the first communication device 110 transmits an SA generation request using the IKE protocol to the second communication device 120 (operation S501). Next, the second communication device 120 transmits an SA generation response using the IKE protocol to the first communication device 110 (operation S502). As a result, an SA1 is established between the first communication device 110 and the second communication device 120.

Next, the first communication device 110 transmits a user signal using an SA1 ESP (Encapsulating Security Payload) packet to the second communication device 120 (operation S503). At this time, as indicated in the table 511, the SA1 transmission byte count does not exceed the byte soft threshold (within range). In this case, the SA1 is “mature” in the first communication device 110.

Next, the first communication device 110 transmits the user signal using the SA1 ESP packet to the second communication device 120 (operation S504). At this time, as indicated in the table 512, the SA1 transmission byte count exceeds the byte soft threshold (soft over). In this case, the SA1 is “dying” in the first communication device 110.

Next, the first communication device 110 transmits a key exchange request using the IKE protocol to the second communication device 120 (operation S505). Next, the second communication device 120 transmits a key exchange response using the IKE protocol to the first communication device 110 (operation S506). As a result, an SA2 is established between the first communication device 110 and the second communication device 120.

At this time, as indicated in the table 513, the SA2 transmission byte count is 0 in the first communication device 110 and the transmission byte count does not exceed the byte soft threshold (within range). As a result, the SA2 is “mature” in the first communication device 110. Furthermore, the first communication device 110 sets the remaining byte count of the SA1 byte hard lifetime as the old SA threshold for the SA2. At this time, the SA2 transmission byte count is 0 and does not exceed the old SA threshold (within range).

Next, the first communication device 110 transmits a user signal using an SA2 ESP packet to the second communication device 120 (operation S507). At this time, as indicated in the table 514, the SA2 transmission byte count in the first communication device 110 does not exceed the byte soft threshold (within range). Furthermore, the SA2 transmission byte count does not exceed the old SA threshold (within range). In this case, the SA1 is “dying” and the SA2 is “mature” in the first communication device 110.

Next, the first communication device 110 transmits a user signal using an SA2 ESP packet to the second communication device 120 (operation S508). At this time, as indicated in the table 515, the SA2 transmission byte count in the first communication device 110 exceeds the old SA threshold, that is, the old SA remaining byte lifetime has expired (hard over). Next, the first communication device 110 transmits an SA deletion request using the IKE protocol to the second communication device 120 (operation S509). As a result, as indicated in the table 516, the SA1 established between the first and second communication devices 110 and 120 is deleted.

In this way, keeping the old SA for a long time and establishing multiple SAs can be avoided by deleting the old SA when the old SA byte hard lifetime remaining byte count is transmitted by the current SA in the first communication device 110 according to the first embodiment. As a result, communication resources can be used effectively. For example, communication problems due to establishing multiple SAs can be avoided.

Furthermore, time hard lifetimes and other timer settings can be separated so that the byte soft lifetime and the byte hard lifetime can be set. As a result, depletion of communication resources and reduced encryption strength can be avoided due to the flexible setting of the byte soft lifetime and the byte hard lifetime. Furthermore, the old SA can be deleted by monitoring the data amount without providing a timer for deleting the old SA. As a result, an increase in the processing load can be reduced.

### Second Embodiment

The configuration example of the first communication device 110 according to the second embodiment is the same as the configuration illustrated in FIG. 1 and the description is omitted here. However, the SA processing unit 114 of the first communication device 110 according to the second embodiment establishes a new SA and transmits old SA identification information to the second communication device 120 when notified that the SA time hard lifetime has expired by the elapsed time monitoring unit 118. The old SA identification information is, for example, an SPI (security parameters index) indicating the old SA.

Furthermore, the SA processing unit 114 may ask the second communication device 120 whether or not the second communication device 120 has an SA deletion function based on the old SA remaining byte lifetime. The SA processing unit 114 sends the old SA identification information to the second communication device 120 if, as a result of the asking, the second communication device 120 has the SA deletion function based on the old SA remaining byte lifetime.

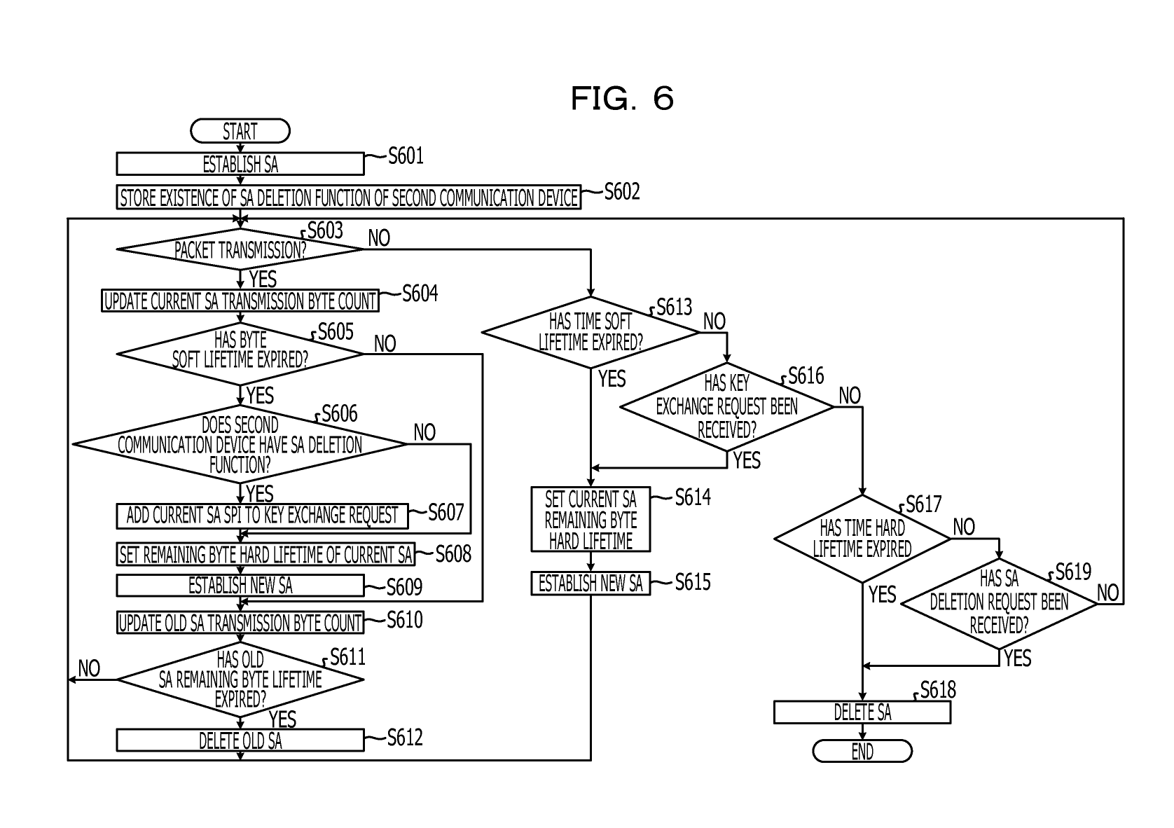

FIG. 6 is a flow chart illustrating an example of operations by the communication devices according to the second embodiment. First, the SA processing unit 114 establishes an SA between the first and second communication devices 110 and 120 when communication between the first and second communication devices 110 and 120 begins (operation S601). In operation S601, the SA processing unit 114 asks the second communication device 120 whether or not the second communication device 120 has an SA deletion function based on the old SA remaining byte lifetime.

Next, the SA processing unit 114 stores, in a memory in the first communication device 110, whether or not the SA deletion function based on the old SA remaining byte lifetime exists in the second communication device 120 based on the asking in operation S601 (operation S602). Next, the encryption processing unit 111 determines whether or not packets have been transmitted through the current SA (operation S603). When the transmission of packets has been determined in operation S603 (operation S603: Yes), the transmission byte count monitoring unit 117 updates the current SA transmission byte count by the byte count of the transmitted packets (operation S604).

Next, the transmission byte count monitoring unit 117 determines whether or not the byte soft lifetime has expired based on the updating in operation S604 (operation S605). If the byte soft lifetime has not expired (operation S605: No), the process moves to operation S610. If the byte soft lifetime has expired (operation S605: Yes), the SA processing unit 114 determines whether or not the second communication device 120 has an SA deletion function based on the old SA remaining byte lifetime using the result of operation S602 (operation S606).

If the second communication device 120 does not have the SA deletion function based on the old SA remaining byte lifetime (operation S606: No), the process moves to operation S608. If the second communication device 120 has the SA deletion function based on the old SA remaining byte lifetime (operation S606: Yes), the SA processing unit 114 adds the current SA SPI (identification information) to the key exchange request to be sent to the second communication device 120 (operation S607).

The operations S608 to S619 in FIG. 6 are the same as operations S405 to S416 in FIG. 4, and or repeated description is omitted here. However, when operation S607 is conducted, the key exchange request to which the SPI is added in operation S607 is transmitted to the second communication device 120 in operation S609.

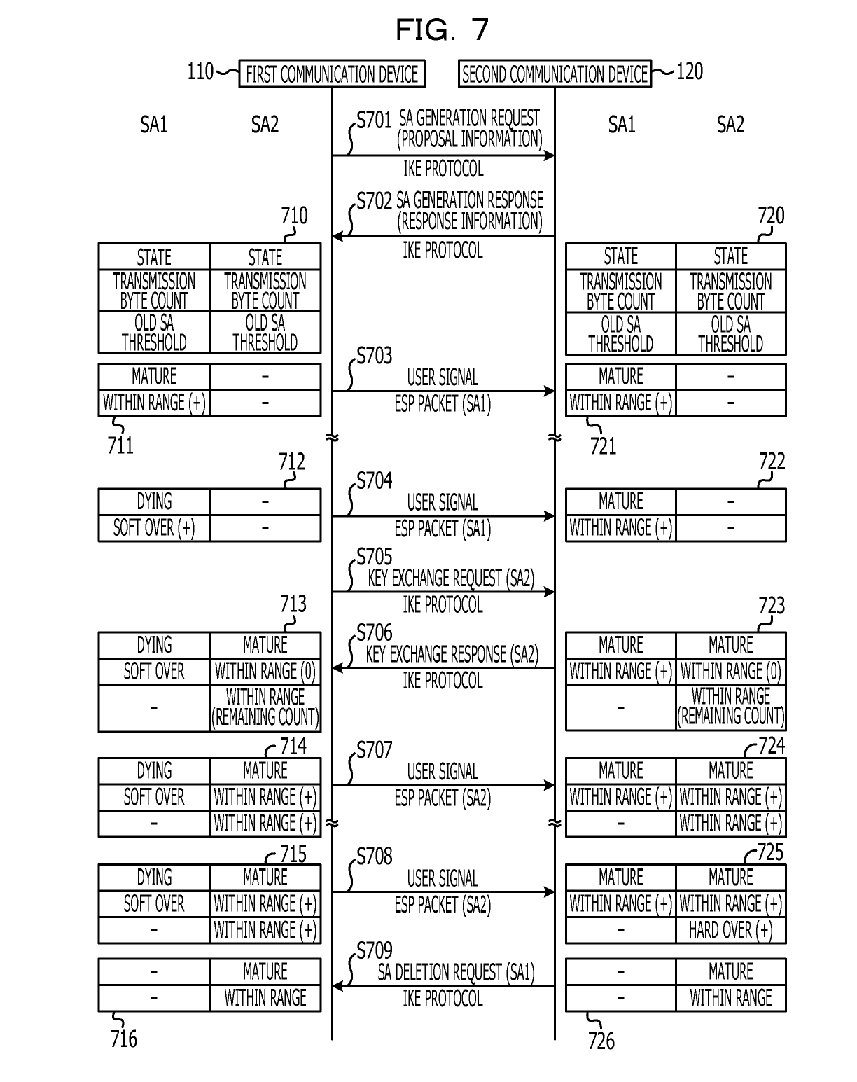

FIG. 7 is a sequence diagram illustrating an example of communication system operations according to the second embodiment. Tables 711 to 716 indicate parameters (see table 710) of the first communication device 110 for operations S703, S704, and S706 to S709 respectively. Tables 721 to 726 indicate parameters (see table 720) of the second communication device 120 for operations S703, S704, and S706 to S709 respectively. Furthermore, the first communication device 110 and the second communication device 120 each have unique byte soft lifetimes, time soft lifetimes, byte hard lifetimes, and time hard lifetimes.

First, the first communication device 110 transmits the SA generation request using the IKE protocol to the second communication device 120 (operation S701). Next, the second communication device 120 transmits the SA generation response using the IKE protocol to the first communication device 110 (operation S702). As a result, an SA1 is established between the first communication device 110 and the second communication device 120.

The SA generation request transmitted in operation S701 includes proposal information that proposes SA deletion based on the old SA remaining byte lifetime to the second communication device 120. Furthermore, the SA generation response transmitted in operation S702 includes response information indicating the occurrence of SA deletion by the second communication device 120 based on the old SA remaining byte lifetime. As a result, the first communication device 110 can recognize whether or not an SA can be deleted by the second communication device 120 based on the old SA remaining byte lifetime.

Next, the first communication device 110 transmits a user signal with an SA1 ESP packet to the second communication device 120 (operation S703). At this time, as indicated in the table 711, the SA1 transmission byte count in the first communication device 110 does not exceed the byte soft threshold (within range). In this case, the SA1 is “mature” in the first communication device 110. As indicated in the table 721, the SA1 transmission byte count in the second communication device 120 does not exceed the byte soft threshold (within range). In this case, the SA1 is “mature” in the second communication device 120.

Next, the first communication device 110 transmits a user signal using an SA1 ESP packet to the second communication device 120 (operation S704). At this time, as indicated in the table 712, the SA1 transmission byte count exceeds the byte soft threshold (soft over) in the first communication device 110. In this case, the SA1 is “dying” in the first communication device 110. As indicated in the table 722, the SA1 transmission byte count in the second communication device 120 does not exceed the byte soft threshold (within range). In this case, the SA1 is “mature” in the second communication device 120.

Next, the first communication device 110 transmits a key exchange request using the IKE protocol to the second communication device 120 (operation S705). The key exchange request transmitted in operation S705 includes the SPI of the SA whose byte soft lifetime has expired in the first communication device 110. Next, the second communication device 120 transmits a key exchange response using the IKE protocol to the first communication device 110 (operation S706). As a result, an SA2 is established between the first communication device 110 and the second communication device 120.

At this time, as indicated in the table 713, the SA2 transmission byte count is 0 in the first communication device 110 and does not exceed the byte soft threshold (within range). As a result, the SA2 is “mature” in the first communication device 110. Furthermore, the first communication device 110 sets the remaining byte count of the SA1 byte hard lifetime as the old SA threshold for the SA2. At this time, the SA2 transmission byte count is 0 and does not exceed the old SA threshold (within range).

At this time, as indicated in the table 723, the SA2 transmission byte count is 0 in the second communication device 120 and does not exceed the byte soft threshold (within range). As a result, the SA2 is “mature” in the second communication device 120. Furthermore, the second communication device 120 sets the remaining byte count of the SA1 byte hard lifetime indicated by the SPI included in the key exchange request transmitted in operation S705, as the old SA threshold for the SA2. At this time, the SA2 transmission byte count is 0 and does not exceed the old SA threshold (within range).

The byte hard lifetimes of the first communication device 110 and the second communication device 120 may be different when setting the byte hard lifetimes in the first communication device 110 and the second communication device 120. In this case, the old SA thresholds set in the first communication device 110 and the second communication device 120 are different. The following describes a case in which the second communication device 120 sets the byte hard lifetime shorter than the byte hard lifetime in the first communication device 110 and the old SA threshold of the second communication device 120 is smaller than the old SA threshold of the first communication device 110.

Next, the first communication device 110 transmits a user signal using an SA2 ESP packet to the second communication device 120 (operation S707). At this time, as indicated in the table 714, the SA2 transmission byte count in the first communication device 110 does not exceed the byte soft threshold (within range). Furthermore, the SA2 transmission byte count does not exceed the old SA threshold (within range). In this case, the SA1 is “dying” and the SA2 is “mature” in the first communication device 110.

As indicated in the table 724, the SA2 transmission byte count in the second communication device 120 does not exceed the byte soft threshold (within range). Furthermore, the SA2 transmission byte count does not exceed the old SA threshold (within range). In this case, the SA1 is “mature” and the SA2 is “mature” in the second communication device 120.

Next, the first communication device 110 transmits a user signal using an SA2 ESP packet to the second communication device 120 (operation S708). At this time, as indicated in the table 715, the SA2 transmission byte count in the first communication device 110 does not exceed the byte soft threshold (within range). Furthermore, the SA2 transmission byte count does not exceed the old SA threshold (within range). In this case, the SA1 is “dying” and the SA2 is “mature” in the first communication device 110.

Further, as indicated in the table 725, the SA2 transmission byte count in the second communication device 120 exceeds the old SA threshold, that is, the old SA remaining byte lifetime has expired (hard over). Next, the second communication device 120 transmits an SA deletion request for the SA1 using the IKE protocol to the first communication device 110 (operation S709). As a result, as indicated in the table 716 and the table 726, the SA1 established between the first and second communication devices 110 and 120 is deleted.

In this way, the first communication device 110 according to the second embodiment transmits the SPI of the SA1 to the second communication device 120 when the byte soft lifetime has expired. As a result, the second communication device 120 can perform SA deletion based on the old SA remaining byte lifetime and exhibit the same effects as the first communication device 110 according to the first embodiment.

Furthermore, the first communication device 110 asks the second communication device 120 whether or not the second communication device 120 has a function to delete an SA based on the old SA remaining byte lifetime and transmits the SPI if the second communication device 120 has that function. If the second communication device 120 does not have the SA deletion function, the SA is deleted by the first communication device 110 based on the old SA remaining byte lifetime. As a result, the first communication device 110 is compatible even in a communication system in which the second communication device 120 temporarily does not have a function to delete the SA based on the old SA remaining byte lifetime.

### Third Embodiment

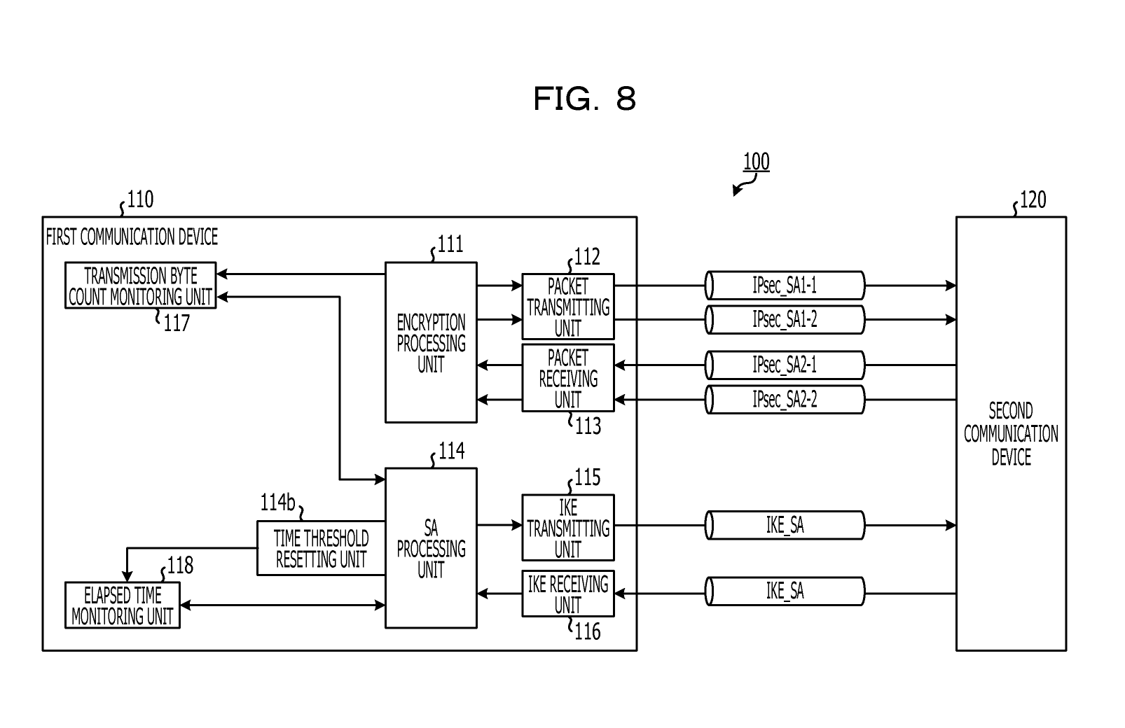

FIG. 8 is a block diagram of a configuration of a communication device according to a third embodiment. In FIG. 8, the structure similar to that illustrated in FIG. 1 is denoted by the same reference symbols and the description thereof is omitted. As illustrated in FIG. 8, the first communication device 110 according to the third embodiment includes a time threshold resetting unit 114b in addition to the structure illustrated in FIG. 1. In this case, the old SA remaining byte count monitoring unit 119 and the remaining lifetime setting unit 114a may be omitted from the configuration illustrated in FIG. 1.

The elapsed time monitoring unit 118 is a second monitoring unit that monitors the time hard lifetime (second lifetime) up to when the elapsed time from the establishment of the SA exceeds the time hard threshold (second threshold). The SA processing unit 114 is a communication path deleting unit that deletes an SA when the time hard threshold (second threshold) monitored by the elapsed time monitoring unit 118 has expired.

The time threshold resetting unit 114b is a shortening unit that shortens the time hard lifetime (second lifetime) set by the elapsed time monitoring unit 118 when the byte soft lifetime (first lifetime) of the current SA has expired. Specifically, the time threshold resetting unit 114b shortens the time hard lifetime by a certain amount after the byte soft lifetime (first lifetime) of the current SA has expired. The certain amount of time is a time period that is long enough to allow a switch from the current SA to a newly established SA to be completed.

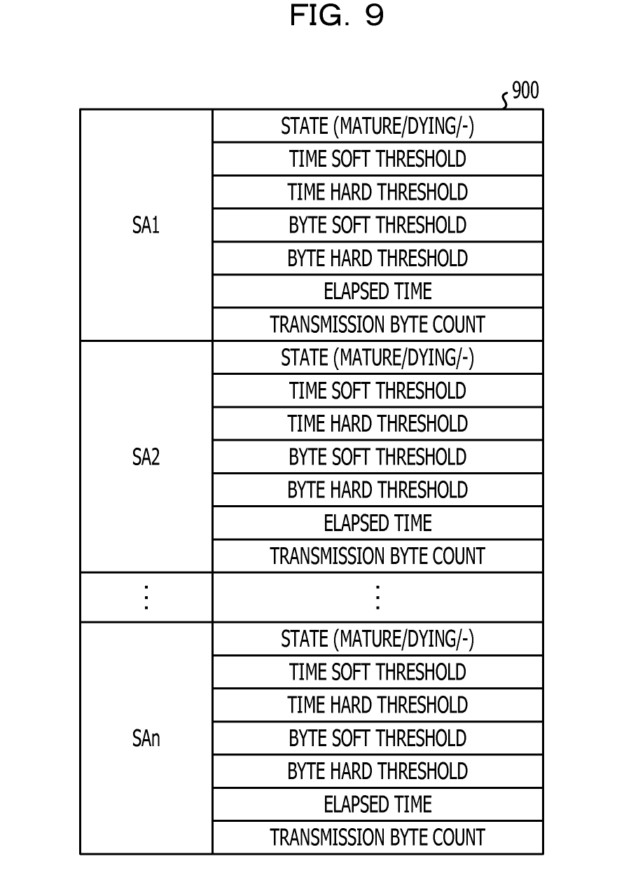

FIG. 9 illustrates an example of information stored in a memory of the communication device according to the third embodiment. A table 900 illustrated in FIG. 9 is an example of information stored in a memory of the first communication device 110. As indicated in the table 900, the first communication device 110 according to the third embodiment may not store the old SA threshold illustrated in FIG. 2. The time threshold resetting unit 114b shortens the time hard lifetime by reducing the time hard threshold for example, when the byte soft lifetime (first lifetime) of the current SA has expired.

For example, the time threshold resetting unit 114b reduces the time hard threshold of the SA1 when the SA1 transmission byte count exceeds the SA1 byte soft threshold and an SA2 is newly established. Similarly, the time threshold resetting unit 114b reduces the time hard threshold of an SAn−1 when the SAn−1 transmission byte count exceeds the SAn−1 byte soft threshold and an SAn is newly established.

However, the reduced time hard threshold is to be larger than the SA elapsed time when the byte soft lifetime has expired. Specifically, the time threshold resetting unit 114b shortens the remaining lifetime of the time hard lifetime. As a result, at the same time the time hard threshold is reduced, the old SA elapsed time can be prevented from exceeding the time hard threshold. Thus, deletion of the old SA before completing the switch to the new SA can be avoided.

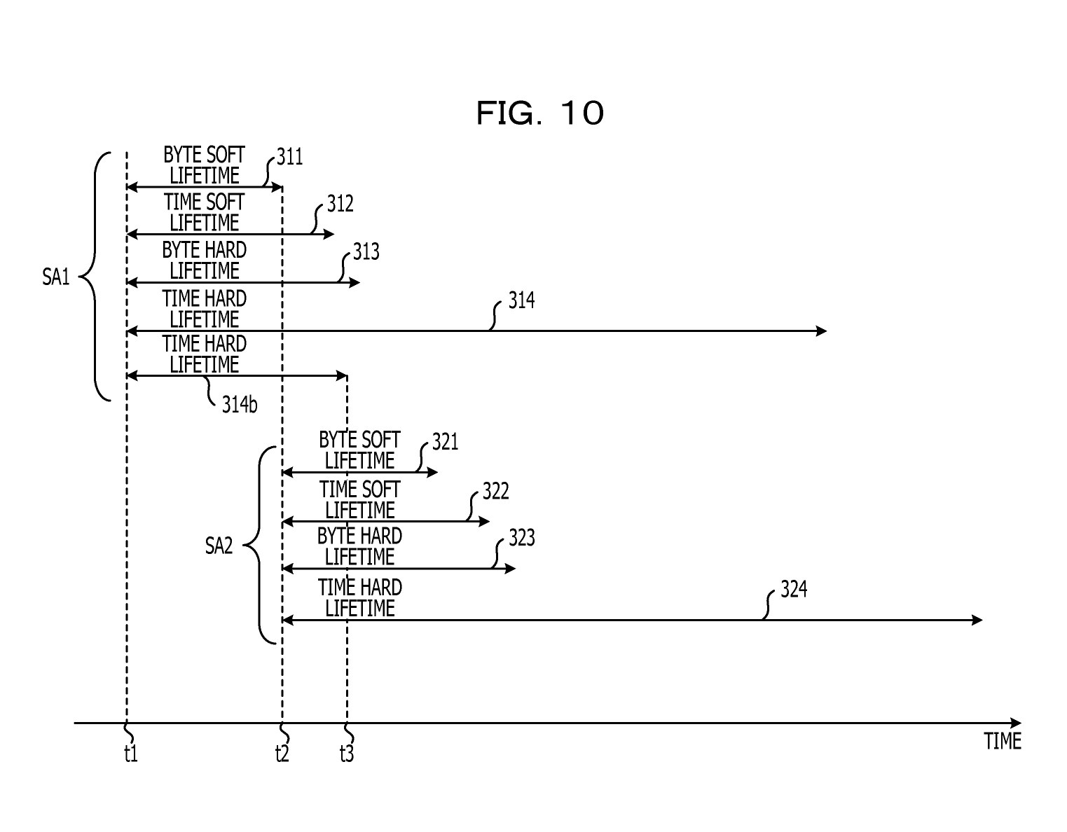

FIG. 10 illustrates an example of deleting an old SA by the communication device according to the third embodiment. In FIG. 10, the structure similar to that illustrated in FIG. 3 is denoted by the same reference symbols and the description thereof is omitted. When the SA2 is established at the time t2, the first communication device 110 shortens a time hard lifetime 314 of the SA1. A time hard lifetime 314b is the shortened time hard lifetime of the SA1.

The first communication device 110 deletes the SA1 at the time t3 when the time hard lifetime 314b expires. Thus, keeping the SA1 for a long time after the SA2 has been established can be avoided even if the time hard lifetime 314 is set as a long time.

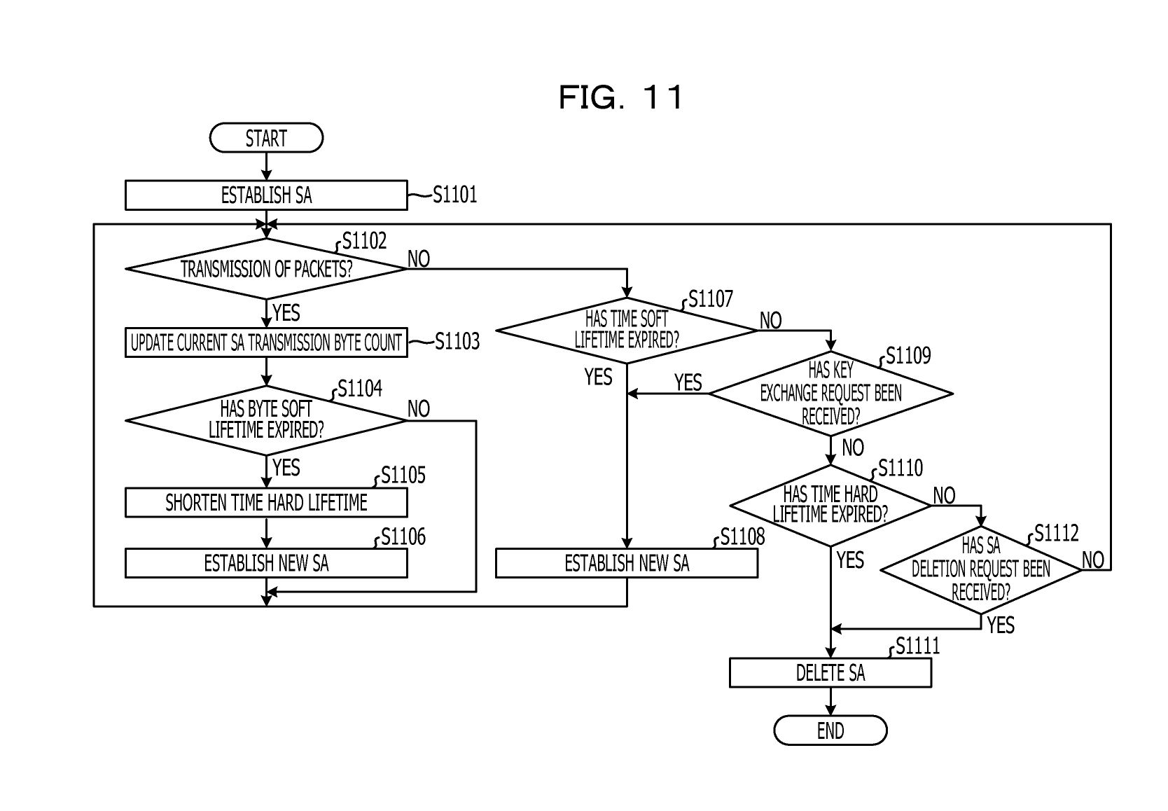

FIG. 11 is a flow chart illustrating an example of operations by the communication device according to the third embodiment. The first communication device 110 illustrated in FIG. 8 executes, for example, the following operations. The operations S1101 to S1104 in FIG. 11 are the same as operations S401 to S404 in FIG. 4 and the description will be omitted here. However, when the byte soft lifetime is not expired (operation S1104: No), the process returns to operation S1102.

When the byte soft lifetime has expired (operation S1104: Yes), the time threshold resetting unit 114b shortens the time hard lifetime of the current SA (operation S1105). Next, the SA processing unit 114 establishes a new SA between the first and second communication devices 110 and 120 (operation S1106) and the process returns to operation S1102.

When there is no packet transmission through the current SA (operation S1102: No), the elapsed time monitoring unit 118 determines whether or not the time soft lifetime of the current SA has expired (operation S1107). If the time soft lifetime has expired (operation S1107: Yes), the SA processing unit 114 establishes a new SA between the first and second communication devices 110 and 120 (operation S1108) and the process returns to operation S1102.

When the time soft lifetime is not expired (operation S1107: No), the process switches to operation S1109. The operations S1109 to S1112 in FIG. 11 are the same as operations S413 to S416 in FIG. 4 and the description will be omitted here.

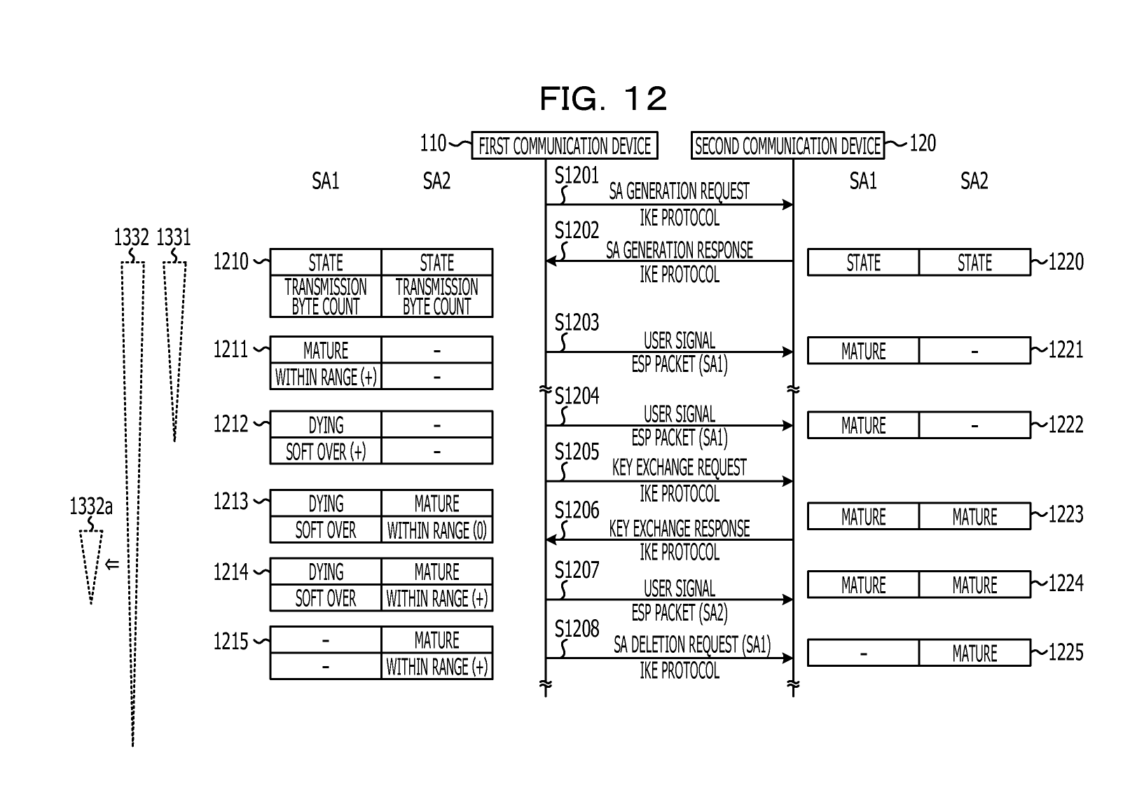

FIG. 12 is a sequence diagram illustrating an example of communication system operations according to the third embodiment. Tables 1211 to 1215 indicate parameters (see table 1210) of the first communication device 110 for operations S1203, S1204, and S1206 to S1208 respectively. Tables 1221 to 1225 indicate parameters (see table 1220) of the second communication device 120 for operations S1203, S1204, and S1206 to S1208 respectively. A time soft lifetime 1331 is the time soft lifetime set in the elapsed time monitoring unit 118 by the SA processing unit 114. A time hard lifetime 1332 is the time hard lifetime set in the elapsed time monitoring unit 118 by the SA processing unit 114.

First, the first communication device 110 transmits an SA generation request using the IKE protocol to the second communication device 120 (operation S1201). Next, the second communication device 120 transmits an SA generation response using the IKE protocol to the first communication device 110 (operation S1202). As a result, an SA1 is established between the first communication device 110 and the second communication device 120.

Next, the first communication device 110 transmits a user signal using an SA1 ESP packet to the second communication device 120 (operation S1203). At this time, as indicated in the table 1211, the SA1 transmission byte count does not exceed the byte soft threshold (within range). In this case, the SA1 is “mature” in the first communication device 110.

Next, the first communication device 110 transmits a user signal using an SA1 ESP packet to the second communication device 120 (operation S1204). At this time, as indicated in the table 1212, the SA1 transmission byte count exceeds the byte soft threshold (soft over). In this case, the SA1 is “dying” in the first communication device 110.

Next, the first communication device 110 transmits a key exchange request using the IKE protocol to the second communication device 120 (operation S1205). Next, the second communication device 120 transmits a key exchange response using the IKE protocol to the first communication device 110 (operation S1206). As a result, an SA2 is established between the first communication device 110 and the second communication device 120.

At this time, as indicated in the table 1213, the SA2 transmission byte count in the first communication device 110 is 0 and does not exceed the byte soft threshold (within range). As a result, the SA2 is “mature” in the first communication device 110. Furthermore, the first communication device 110 shortens the remaining lifetime of the time hard lifetime 1332. A time hard lifetime 1332a indicates a lifetime shortened by the first communication device 110.

Next, the first communication device 110 transmits a user signal using an SA2 ESP packet to the second communication device 120 (operation S1207). At this time, as indicated in the table 1214, the SA2 transmission byte count does not exceed the byte soft threshold (within range). Conversely, the time hard lifetime 1332a is expired at this time. Next, the first communication device 110 transmits an SA1 SA deletion request using the IKE protocol to the second communication device 120 (operation S1208). As a result, as indicated in the table 1215, the SA1 established between the first and second communication devices 110 and 120 is deleted.

In this way, the first communication device 110 according to the third embodiment can shorten the old SA remaining time to avoid keeping the old SA for a long time and establishing multiple SAs by shortening the time hard lifetime when the byte soft lifetime has expired. As a result, communication resources can be used effectively. For example, communication problems due to establishing multiple SAs can be avoided.

Furthermore, time hard lifetimes and other timer settings can be separated so that the byte soft lifetime and the byte hard lifetime can be set. As a result, depletion of communication resources and reduced encryption strength can be avoided due to the flexible setting of the byte soft lifetime and the byte hard lifetime. Furthermore, the old SA can be deleted by monitoring the data amount without providing a timer for deleting the old SA. As a result, an increase in the processing load can be prevented.

### Fourth Embodiment

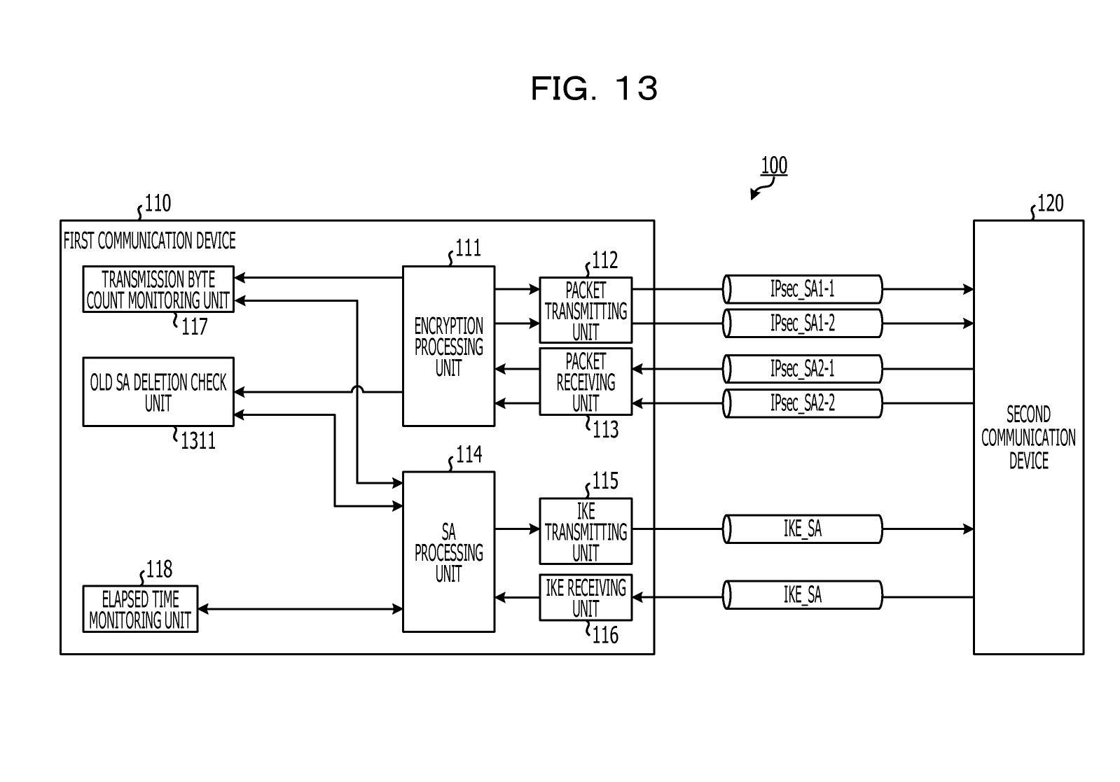

FIG. 13 is a block diagram of a configuration of a communication device according to a fourth embodiment. In FIG. 13, the structure similar to that illustrated in FIG. 1 is denoted by the same reference symbols and the description thereof is omitted. As illustrated in FIG. 13, the first communication device 110 according to the fourth embodiment includes an old SA deletion check unit 1311 in addition to the structure illustrated in FIG. 1. In this case, the old SA remaining byte count monitoring unit 119 and the remaining lifetime setting unit 114a illustrated in FIG. 1 may be omitted from the configuration.

The transmission byte count monitoring unit 117 is a monitoring unit that monitors the byte soft lifetime (lifetime) until the byte count (data amount) transmitted through the current SA (first encryption communication path) established between the first and second communication devices 110 and 120 exceeds the byte soft threshold (threshold).

The SA processing unit 114 is a communication path establishing unit that establishes a new SA (second encryption communication path) between the first and second communication devices 110 and 120 when the byte soft lifetime monitored by the transmission byte count monitoring unit 117 has expired. The SA processing unit 114 notifies the old SA deletion check unit 1311 that a new SA is established when the new SA is established. Furthermore, the SA processing unit 114 is a communication path deletion unit that deletes the old SA (first encryption communication path) when notified by the old SA deletion check unit 1311 that an old SA deletion check response (response signal) has been received.

The old SA deletion check unit 1311 is a transmitting unit that transmits an old SA deletion check request (check signal) to the second communication device 120 when the current SA byte soft lifetime has expired. Specifically, the old SA deletion check unit 1311 outputs the old SA deletion check request to the encryption processing unit 111 when notified by the SA processing unit 114 that the new SA has been established.

For example, the old SA deletion check unit 1311 transmits, as an old SA deletion check request, a signal with a priority lower than the priority of other data (for example, user data) transmitted through the old SA. Furthermore, the old SA deletion check unit 1311 may also transmit, as the old SA deletion check request, a signal that is larger in size (for example, the maximum frame size that can be transmitted) than other data transmitted through the old SA. Furthermore, the old SA deletion check unit 1311 may also transmit, as the old SA deletion check request, a signal that is lower in priority and larger in size than other data transmitted through the old SA.

Furthermore, the old SA deletion check unit 1311 is a receiving unit that receives an old SA deletion check response (response signal) from the second communication device 120 in response to the transmitted old SA deletion check request. Specifically, the old SA deletion check unit 1311 receives the response signal outputted by the encryption processing unit 111. Furthermore, the old SA deletion check unit 1311 notifies the SA processing unit 114 that the response signal has been received when the response signal has been received in response to the old SA deletion check request.

The old SA deletion check request outputted by the old SA deletion check unit 1311 is encrypted by the encryption processing unit 111 and transmitted to the second communication device 120 through the current SA from the packet transmitting unit 112. Furthermore, the old SA deletion check response transmitted from the second communication device 120, in response to the transmitted old SA deletion check request, is received by the packet receiving unit 113, decrypted by the encryption processing unit 111, and outputted to the old SA deletion check unit 1311.

The old SA deletion check unit 1311 may repeatedly transmit the old SA deletion check request. Furthermore, the old SA deletion check unit 1311 notifies the SA processing unit 114 that the response signal has been received a specific number of times when the response signal has been received the specific number of times (multiple number of times) in response to the old SA deletion check request. The SA processing unit 114 deletes the old SA when notified by the old SA deletion check unit 1311 that the old SA deletion check response has been received the specific number of times.

The old SA deletion check request and the old SA deletion check response may use echo requests and responses such as ICMP Echo or GTPU Echo. In this case, for example, the echo is transmitted and received through a large size and low priority QoS (for example, DSCP: Differentiated Services Code Point).

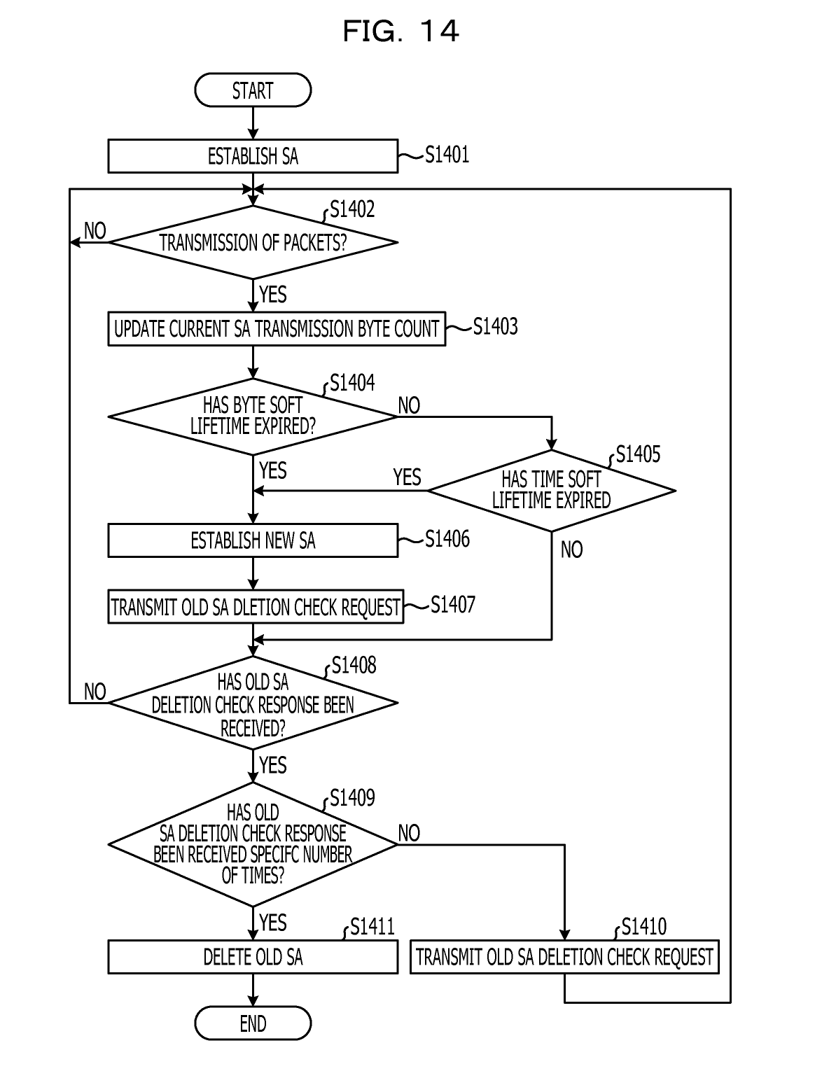

FIG. 14 is a flow chart illustrating an example of operations by the communication device according to the fourth embodiment. The first communication device 110 illustrated in FIG. 13 executes, for example, the following operations. First, the SA processing unit 114 establishes an SA between the first and second communication devices 110 and 120 when communication between the first and second communication devices 110 and 120 begins (operation S1401).

Next, the encryption processing unit 111 determines whether or not packet transmission through the current SA is occurring (operation S1402) and waits until packet transmission occurs (operation S1402: No loop). When the transmission of packets has been determined in operation S1402 (operation S1402: Yes), the transmission byte count monitoring unit 117 updates the byte count transmitted through the current SA by the byte count of the transmitted packets (operation S1403). Next, the transmission byte count monitoring unit 117 determines whether or not the byte soft lifetime has expired based on the updating in operation S1403 (operation S1404).

If the byte soft lifetime is not expired (operation S1404: No), the elapsed time monitoring unit 118 determines whether or not the time soft lifetime has expired (operation S1405). If the time soft lifetime has not expired (operation S1405: No), the process moves to operation S1408.

If the byte soft lifetime has expired (operation S1404: Yes), or if the time soft lifetime has expired (operation S1405: Yes), the SA processing unit 114 establishes a new SA between the first and second communication devices 110 and 120 (operation S1406). Next, the old SA deletion check unit 1311 transmits the old SA deletion check request to the second communication device 120 through the old SA (operation S1407).

Next, whether or not the old SA deletion check response corresponding to the old SA deletion check request transmitted in operation S1407 has been received is determined (operation S1408). If the SA deletion check response has not been received (operation S1408: No), the process returns to operation S1402. If the old SA deletion check response has been received (operation S1408: Yes), whether or not the old SA deletion check response has been received a specific number of times is determined (operation S1409).

If the old SA deletion check response has not been received the specific number of times (operation S1409: No), the old SA deletion check unit 1311 retransmits the old SA deletion check request to the second communication device 120 (operation S1410), and the process returns to operation S1402. If the old SA deletion check response has been received the specific number of times (operation S1409: Yes), the SA processing unit 114 deletes the old SA (operation S1411) and the series of operations is completed.

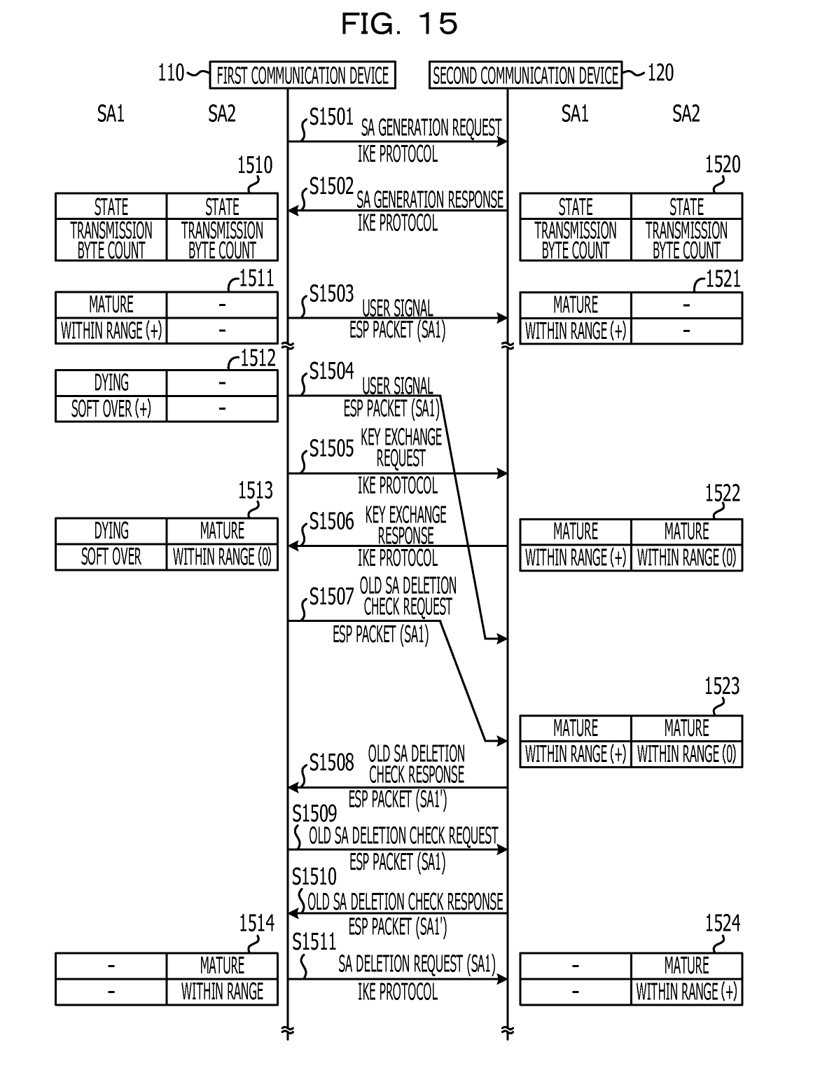

FIG. 15 is a sequence diagram illustrating an example of communication system operations according to the fourth embodiment. Tables 1511 to 1514 indicate parameters (see table 1510) of the first communication device 110 for operations S1503, S1504, S1506, and S1511 respectively. Tables 1521 to 1524 indicate parameters (see table 1520) of the second communication device 120 for operations S1503, S1506, S1507, and S1511 respectively.

The operations S1501 to S1506 in FIG. 15 are the same as operations S501 to S506 in FIG. 5 and their description will be omitted here. However, the transmission of the user signal transmitted in operation S1504 is delayed and is not received at this time in the second communication device 120.

After operation S1506, the first communication device 110 transmits the old SA deletion check request using an SA1 ESP packet to the second communication device 120 (operation S1507). Next, the user signal transmitted in operation S1504 is received by the second communication device 120, and then the old SA deletion check request transmitted in operation S1507 is received by the second communication device 120.

Next, the second communication device 120 transmits the old SA deletion check response through an SA1′ ESP packet to the first communication device 110 (operation S1508). The SA1′, which extends from the first communication device 110 to the second communication device 120, is an SA in the opposite direction from the SA1. Next, the first communication device 110 transmits the old SA deletion check request using the SA1 ESP packet to the second communication device 120 (operation S1509). Next, the second communication device 120 transmits the old SA deletion check response using the SA1′ ESP packet to the first communication device 110 (operation S1510).

As a result, the number of times the first communication device 110 receives the old SA deletion check response meets the specific number of times (where the specific number of times=2 times). Next, the first communication device 110 transmits an SA1 SA deletion request using the IKE protocol to the second communication device 120 (operation S1511). As a result, as indicated in the table 1514 and the table 1524, the SA1 established between the first and second communication devices 110 and 120 is deleted.

In this way, the first communication device 110 according to the fourth embodiment transmits the old SA deletion request to the second communication device 120 when the byte soft lifetime is expired, and receives, from the second communication device 120, the old SA deletion check response corresponding to the transmitted old SA deletion check request. As a result, the completion of the transmission of data through the old SA can be confirmed. The first communication device 110 can delete the old SA after the data transmission through the old SA has been completed by deleting the old SA when the old SA deletion check response has been received.

In this way, the old SA remaining time is shortened so that the old SA is not kept for a long time and the establishment of multiple SAs can be avoided while ensuring the transmission of data through the old SA. As a result, communication resources can be used effectively. For example, communication problems due to establishing multiple SAs can be avoided.

Furthermore, time hard lifetimes and other timer settings can be separated so that the byte soft lifetime and the byte hard lifetime can be set. As a result, depletion of communication resources and reduced encryption strength can be avoided due to the flexible setting of the byte soft lifetime and the byte hard lifetime. Furthermore, the old SA can be deleted by monitoring the data amount without providing a timer for deleting the old SA. As a result, an increase in the processing load can be prevented.

Furthermore, transmitting and receiving the old SA deletion check request and the old SA deletion check response before transmitting and receiving other data can be avoided since a signal with a response priority lower than other data transmitted through the old SA can be transmitted as an old SA deletion check request. As a result, the completion of the transmission of data through the old SA can be accurately confirmed.

Furthermore, the probability of transmitting and receiving the old SA deletion check request and the old SA deletion check response before other data can be reduced by transmitting a signal larger in size than other data transmitted through the old SA as the old SA deletion check request. As a result, the completion of the transmission of data through the old SA can be accurately confirmed.

Furthermore, completion of the transmission of other data through the old SA can be accurately confirmed and the old SA can be deleted by repeatedly transmitting the old SA deletion check request, waiting until the old SA deletion check response has been received a specific number of times, and then deleting the old SA.

(Communication System Application Example)

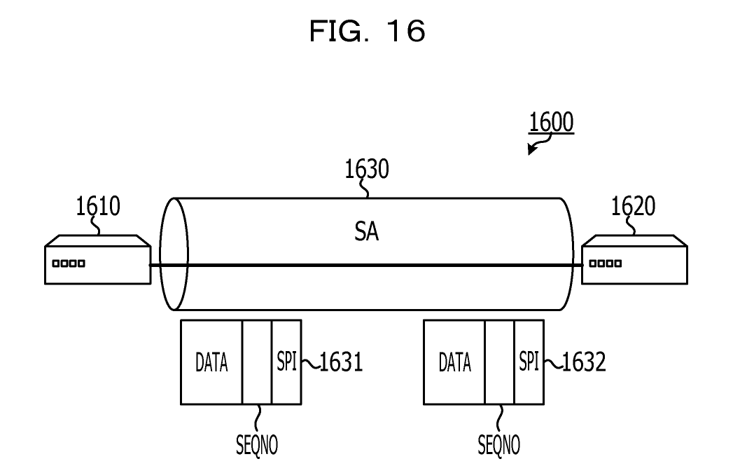

FIG. 16 is a first application example of a communication system according to the embodiments. As illustrated in FIG. 16, an IPsec network 1600 includes a node 1610 and a node 1620. The nodes 1610 and 1620 are IPsec compatible. An SA 1630 (IP tunnel) is set between the node 1610 and the node 1620. For example, the node 1610 is an LTE-defined Node A, and the node 1620 is an LTE-defined Node B (wireless base station).

Frames 1631 and 1632 are frames to be transmitted from the node 1610 to the node 1620. The frames 1631 and 1632 both include an SPI indicating an SA, a sequence number (SeqNo), and user data (Data). The aforementioned embodiments of the first communication device 110 and the second communication device 120 can be used as the node 1610 and the node 1620 respectively. As a result, communication resources can be used effectively for communication between the node 1610 and the node 1620.

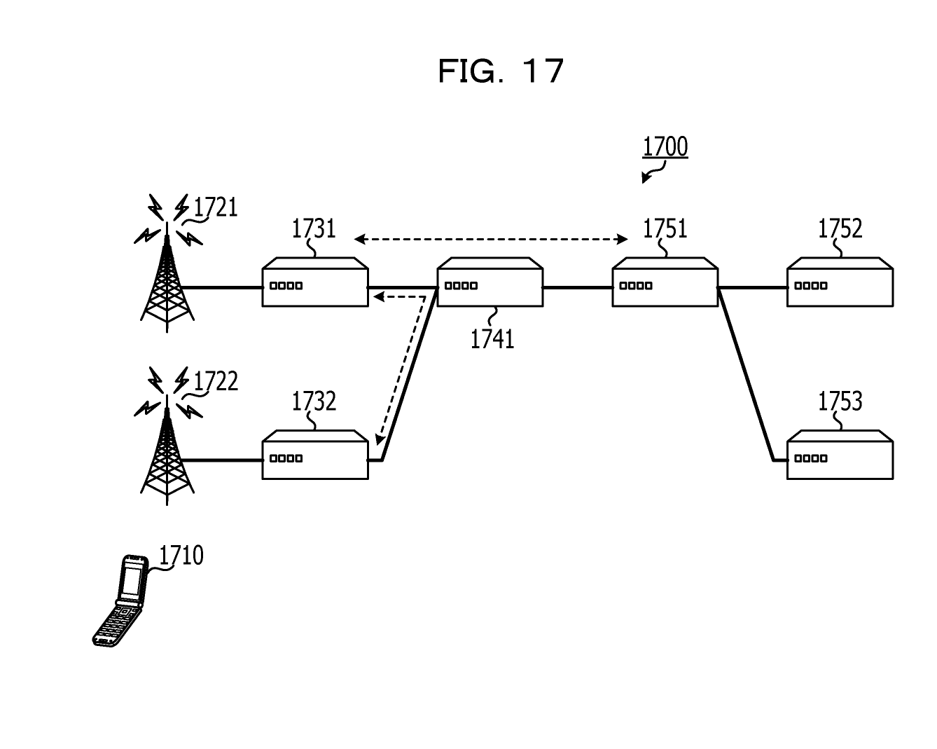

FIG. 17 is a second application example of a communication system according to the embodiments. As illustrated in FIG. 17, an LTE network 1700 includes a mobile station 1710, antennas 1721 and 1722, wireless base stations 1731 and 1732, a router 1741, a security gateway 1751, and serving gateways 1752 and 1753. In FIG. 17, the dotted line arrows indicate zones encrypted by IPsec tunnels.

The mobile station 1710 is a user terminal (UE: User Equipment) that conducts wireless communication. The wireless base stations 1731 and 1732 are wireless base stations (eNodeB: evolved NodeB) that conduct wireless communication with the first communication device 110 through the antennas 1721 and 1722 respectively.

The wireless base stations 1731 and 1732 are each connected to the security gateway 1751 through the router 1741. The wireless base stations 1731 and 1732 conduct communication with the security gateway 1751 using IPsec. The security gateway 1751 is connected to the serving gateways 1752 and 1753. The serving gateways 1752 and 1753 are connected to a not illustrated PDN-GW (Packet Data Network Gateway).

The first communication device 110 according to the above embodiments can be applicable to, for example, the security gateway 1751. In this case, the second communication device 120 according to the above embodiments may be applicable to, for example, the wireless base stations 1731 and 1732. As a result, communication resources can be used effectively in communication between the security gateway 1751 and the wireless base stations 1731 and 1732.

Further, the first communication device 110 according to the above embodiments may be applicable to the wireless base stations 1731 and 1732. In this case, the second communication device 120 according to the above embodiments may be applicable to, for example, the security gateway 1751. As a result, communication resources can be used effectively in communication between the security gateway 1751 and the wireless base stations 1731 and 1732.

Using the communication device and communication method as described above allows for the effective use of communication resources. A configuration in which the byte count is monitored as the data amount transmitted through the SA has been described in the above embodiments. However, the data amount transmitted through the SA is not limited to the byte count. For example, a packet count and the like may be monitored as the data amount transmitted through the SA.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of superiority and inferiority of the invention. Although the embodiments of the present invention have been described in detail, it should be understood that various changes, substitutions, and alternations could be made hereto without departing from the spirit and scope of the invention.

1. A communication device comprising:
a first monitoring unit that monitors a first lifetime until a data amount transmitted through a first encryption communication path established between the communication device and another communication device exceeds a first threshold,
a second monitoring unit that monitors a second lifetime until the data amount transmitted through the first encryption communication path exceeds a second threshold that is larger than the first threshold,
a communication path establishing unit that establishes a second encryption communication path different from the first encryption communication path between the communication device and the other communication device when the first lifetime monitored by the first monitoring unit expires, and
a communication path deleting unit that deletes the first encryption communication path when the data amount transmitted through the second encryption communication path established by the communication path establishing unit exceeds a remaining data amount of the second lifetime monitored by the second monitoring unit.

2. The communication device according to claim 1, further comprising:
a setting unit that sets a third threshold that corresponds to the remaining data amount of the second lifetime when the first lifetime expires, and
a third monitoring unit that monitors a third lifetime until the data amount transmitted through the second encryption communication path exceeds the third threshold set by the setting unit, wherein
the communication path deleting unit deletes the first encryption communication path when the third lifetime monitored by the third monitoring unit expires.

3. The communication device according to claim 1 wherein,
the second monitoring unit monitors a third lifetime until a sum of the data amount transmitted through the first encryption communication path and the data amount transmitted through the second encryption communication path exceeds the second threshold after the second encryption communication path is established, and
the communication path deleting unit deletes the first encryption communication path when the third lifetime monitored by the second monitoring unit expires.

4. The communication device according to claim 3, further comprising:
a transmitting unit that transmits identification information that identifies the first encryption communication path to the other communication device when the first lifetime expires.

5. The communication device according to claim 4 wherein,
the communication path establishing unit asks the other communication device whether or not the other communication device has a function to delete the first encryption communication path based on the third lifetime, and
the transmitting unit transmits the identification information when the other communication device has the function.

6. A communication device comprising:
a first monitoring unit that monitors a first lifetime until a data amount transmitted through a first encryption communication path established between the communication device and another communication device exceeds a first threshold,
a second monitoring unit that monitors a second lifetime until an elapsed time from when the first encryption communication path is established exceeds a second threshold,
a communication path establishing unit that establishes a second encryption communication path different from the first encryption communication path between the communication device and the other communication device when the first lifetime monitored by the first monitoring unit expires,
a shortening unit that shortens the second lifetime when the first lifetime monitored by the first monitoring unit expires, and
a communication path deleting unit that deletes the first encryption communication path when the second lifetime monitored by the second monitoring unit expires.

7. The communication device according to claim 6, wherein the shortening unit shortens a remaining lifetime of the second lifetime.

8. A communication device comprising:
a monitoring unit that monitors a lifetime until a data amount transmitted through a first encryption communication path established between the communication device and another communication device exceeds a threshold,
a communication path establishing unit that establishes a second encryption communication path different from the first encryption communication path between the communication device and the other communication device when the lifetime monitored by the monitoring unit expires,
a transmitting unit that transmits a confirmation signal to the other communication device through the first encryption communication path when the lifetime monitored by the monitoring unit expires,
a receiving unit that receives a response signal corresponding to the confirmation signal transmitted by the transmitting unit, and
a communication path deleting unit that deletes the first encryption communication path when the response signal is received by the receiving unit.

9. The communication device according to claim 8, wherein the transmitting unit transmits the confirmation signal with a response priority lower than that of other data transmitted through the first encryption communication path.

10. The communication device according to claim 8, wherein the transmitting unit transmits the confirmation signal whose size is larger than that of other data transmitted through the first encryption communication path.

11. The communication device according to claim 8, wherein
the transmitting unit repeatedly transmits the confirmation signal to the other communication device, and
the communication path deleting unit deletes the first encryption communication path when the response signal is received a specific number of times by the receiving unit.

12. A communication method comprising:
a first monitoring process that monitors a first lifetime until a data amount transmitted through a first encryption communication path established between a communication device and another communication device exceeds a first threshold,
a second monitoring process that monitors a second lifetime until the data amount transmitted through the first encryption communication path exceeds a second threshold that is larger than the first threshold,
a communication path establishing process that establishes a second encryption communication path different from the first encryption communication path between the communication device and the other communication device when the first lifetime monitored by the first monitoring unit expires, and
a communication path deleting process that deletes the first encryption communication path when the data amount transmitted through the second encryption communication path established by the communication path establishing process exceeds a remaining data amount of the second lifetime monitored by the second monitoring process.

13. A communication method comprising:
a first monitoring process that monitors a first lifetime until a data amount transmitted through a first encryption communication path established between a communication device and another communication device exceeds a first threshold,
a second monitoring process that monitors a second lifetime until an elapsed time from when the first encryption communication path is established exceeds a second threshold,
a communication path establishing process that establishes a second encryption communication path different from the first encryption communication path between the communication device and the other communication device when the first lifetime monitored by the first monitoring process expires,
a shortening process that shortens the second lifetime when the first lifetime monitored by the first monitoring process expires, and
a communication path deleting process that deletes the first encryption communication path when the second lifetime monitored by the second monitoring process expires.

14. A communication method comprising:
a monitoring process that monitors a lifetime until a data amount transmitted through a first encryption communication path established between a communication device and another communication device exceeds a threshold,
a communication path establishing process that establishes a second encryption communication path different from the first encryption communication path between the communication device and the other communication device when the lifetime monitored by the monitoring process expires,
a transmitting process that transmits a confirmation signal to the other communication device through the first encryption communication path when the lifetime monitored by the monitoring process expires,
a receiving process that receives a response signal corresponding to the confirmation signal transmitted by the transmitting process, and
a communication path deleting process that deletes the first encryption communication path when the response signal is received by the receiving process.
